(19) United States
(12) Patent Application Publication
(10) Pub. No.: US 2026/0299132 A1
(43) Pub. Date: Oct. 1, 2026

(54) DISTANCE IMAGE CAPTURING DEVICE AND CONTROL METHOD

(71) Applicant: TOPPAN Holdings Inc., Tokyo (JP)

(72) Inventor: Tetsuya IIDA, Tokyo (JP)

(73) Assignee: TOPPAN Holdings Inc., Tokyo (JP)

(21) Appl. No.: 19/578,431

(22) Filed: Mar. 25, 2026

(30) Foreign Application Priority Data
Mar. 28, 2025 (JP) 2025-054955

(51) Int. Cl. G01S 17/89; G01S 7/481; H04N 23/56; H04N 25/77

(52) U.S. Cl. CPC G01S 17/89; G01S 7/4816; H04N 23/56; H04N 25/77

(57) ABSTRACT

A distance image capturing device includes a light source unit, a light reception unit including a pixel circuit and a pixel drive circuit, the pixel circuit including a photoelectric conversion element and a charge accumulation unit, and a distance image processing unit. A plurality of the pixel circuits are arranged in a two-dimensional matrix. Each of the pixel circuits includes a transfer transistor configured to transfer the charge from the photoelectric conversion element to each of the charge accumulation units, and a reset transistor configured to discharge the charge accumulated in the charge accumulation units and reset the charge accumulation units, and the distance image processing unit controls the reset transistor such that, in each predetermined control unit of the pixel circuits, the number of repetitions differs during a repetition period in which the charge is repeatedly distributed.

### CROSS REFERENCE TO RELATED APPLICATIONS

This application is a continuation application based on Japanese Patent Application No. 2025-054955, filed on Mar. 28, 2025, in the Japan Patent Office. The contents of the Japanese Patent Application are incorporated herein by reference.

### BACKGROUND OF THE INVENTION

### Field of the Invention

The present invention relates to a distance image capturing device and a control method.

### Description of Related Art

A time of flight (hereinafter, referred to as “TOF”) type distance image capturing device that utilizes the fact that the speed of light is known and measures a distance between a measuring instrument and a target object based on a flight time of light in a space (measurement space) has been realized (for example, see Japanese Patent No. 4235729). In an imaging device such as a distance image capturing device, for example, imaging is performed using a distance image imaging element including a photoelectric conversion element such as a photodiode. In addition, in the TOF type distance image capturing device, there is known a device including a photoelectric conversion element that converts an amount of incident light into charge and a distance image imaging element that distributes and accumulates the charge converted by the photoelectric conversion element in a plurality of charge accumulation units.

### SUMMARY OF THE INVENTION

In the distance image capturing device in the related art as described above, in a case where an object having a different reflectance is imaged when capturing a distance image, a difference in signal amount occurs due to the reflectance even at the same distance.

Therefore, in the distance image capturing device in the related art, for example, in a case where imaging is performed under one condition, it may not be possible to accurately measure the distance due to saturation or insufficient signal amount depending on the reflectance or the distance. To deal with such a case, in the distance image capturing device in the related art, high dynamic range (HDR) processing is performed in which data obtained under imaging conditions corresponding to different reflectances is synthesized.

In the distance image capturing device in the related art, as a method of performing the HDR processing, for example, by changing the number of times of distribution drive in which charge is transferred from a photodiode to a charge accumulation unit in a column unit or a row unit, HDR imaging can be performed in the same frame period.

However, in the distance image capturing device in the related art, for example, in a case where different imaging conditions are realized in a row and a column, there is a problem in that the number of in-pixel wirings increases and the control becomes complicated.

The present invention has been made to solve the above problems, and an object of the present invention is to provide a distance image capturing device and a control method capable of realizing HDR processing by simple control while suppressing an increase in control lines.

To solve the above problems, according to an aspect of the present invention, there is provided a distance image capturing device including: a light source unit configured to irradiate a measurement space in which a subject exists with a light pulse; a light reception unit including a pixel circuit and a pixel drive circuit, the pixel circuit including a photoelectric conversion element configured to generate charge corresponding to incident light and a plurality of charge accumulation units configured to accumulate the charge, the pixel drive circuit being configured to, at a predetermined timing synchronized with irradiation of the light pulse, distribute the charge to each of the charge accumulation units in the pixel circuit and accumulate the charge in each of the charge accumulation units; and a distance image processing unit configured to determine a measurement distance to the subject based on a charge amount accumulated in each of the charge accumulation units, in which a plurality of the pixel circuits are disposed in a two-dimensional matrix, each of the pixel circuits includes a transfer transistor corresponding to each of the plurality of charge accumulation units, the transfer transistor being configured to transfer the charge from the photoelectric conversion element to each of the charge accumulation units, and a reset transistor configured to discharge the charge accumulated in the charge accumulation units and reset the charge accumulation units, and the distance image processing unit causes the transfer transistor to repeatedly distribute the charge, and controls the reset transistors such that, in each predetermined control unit of the pixel circuits arranged in the two-dimensional matrix, the number of repetitions differs during a repetition period in which the charge is repeatedly distributed.

In addition, according to another aspect of the present invention, there is provided a control method of a distance image capturing device including a light source unit configured to irradiate a measurement space in which a subject exists with a light pulse, a light reception unit including a pixel circuit and a pixel drive circuit, the pixel circuit including a photoelectric conversion element configured to generate charge corresponding to incident light and a plurality of charge accumulation units configured to accumulate the charge, the pixel drive circuit being configured to, at a predetermined timing synchronized with irradiation of the light pulse, distribute the charge to each of the charge accumulation units in the pixel circuit and accumulate the charge in each of the charge accumulation units, and a distance image processing unit configured to determine a measurement distance to the subject based on a charge amount accumulated in each of the charge accumulation units, in which a plurality of the pixel circuits are disposed in a two-dimensional matrix, each of the pixel circuits includes a transfer transistor corresponding to each of the plurality of charge accumulation units, the transfer transistor being configured to transfer the charge from the photoelectric conversion element to each of the charge accumulation units, and a reset transistor configured to discharge the charge accumulated in the charge accumulation units and reset the charge accumulation units, the control method including: a control step of causing, by the distance image processing unit, the transfer transistor to repeatedly distribute the charge, and controlling the reset transistors such that, in each predetermined control unit of the pixel circuits arranged in the two-dimensional matrix, the number of repetitions differs during a repetition period in which the charge is repeatedly distributed.

According to the present invention, it is possible to realize HDR processing by simple control while suppressing an increase in control lines.

### BRIEF DESCRIPTION OF THE DRAWINGS

FIG. 1 is a block diagram showing an example of a distance image capturing device according to the present embodiment.

FIG. 2 is a block diagram showing an example of a distance image sensor according to the present embodiment.

FIG. 3 is a block diagram showing an example of a pixel circuit according to the present embodiment.

FIG. 4 is a diagram showing an example of a basic operation of charge distribution processing of the distance image capturing device according to the present embodiment.

FIG. 5A is a diagram showing an example of an operation of HDR processing of the distance image capturing device according to the present embodiment.

FIG. 5B is a diagram showing an example of an operation of HDR processing of the distance image capturing device according to the present embodiment.

FIG. 5C is a diagram showing an example of an operation of HDR processing of the distance image capturing device according to the present embodiment.

FIG. 6 is a flowchart showing an example of control processing of HDR processing of the distance image capturing device according to the present embodiment.

FIG. 7A is a diagram showing a first modification example of the operation of HDR processing of the distance image capturing device according to the present embodiment.

FIG. 7B is a diagram showing a first modification example of the operation of HDR processing of the distance image capturing device according to the present embodiment.

FIG. 7C is a diagram showing a first modification example of the operation of HDR processing of the distance image capturing device according to the present embodiment.

FIG. 8 is a flowchart showing an example of control processing of HDR processing of the distance image capturing device according to the first modification example of the present embodiment.

FIG. 9 is a diagram showing an example of a distance image sensor in a case where HDR processing is performed in a distance image capturing device in the related art.

FIG. 10A is a diagram showing a second modification example of the operation of HDR processing of the distance image capturing device according to the present embodiment.

FIG. 10B is a diagram showing a second modification example of the operation of HDR processing of the distance image capturing device according to the present embodiment.

### DETAILED DESCRIPTION OF THE INVENTION

Hereinafter, a distance image capturing device according to an embodiment of the present invention will be described with reference to the drawings.

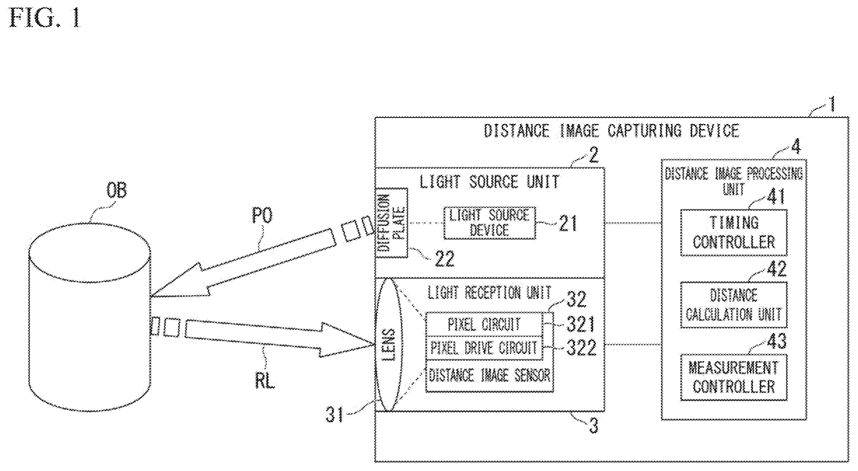

FIG. 1 is a block diagram showing an example of a distance image capturing device 1 according to the present embodiment.

As shown in FIG. 1, the distance image capturing device 1 includes a light source unit 2, a light reception unit 3, and a distance image processing unit 4. It is noted that in FIG. 1, a subject OB, which is a target object for which a distance is measured using the distance image capturing device 1, is also shown.

The light source unit 2 irradiates an imaging-target space in accordance with control from the distance image processing unit 4 with a light pulse PO. The subject OB which is a target for distance measurement in the distance image capturing device 1 exists in the imaging-target space. The light source unit 2 is, for example, a surface emitting semiconductor laser module such as a vertical cavity surface emitting laser (VCSEL). In addition, the light source unit 2 includes a light source device 21 and a diffusion plate 22.

The light source device 21 is a light source that emits laser light in a near-infrared wavelength range (for example, a wavelength range of 850 nm to 940 nm) that is the light pulse PO to be irradiated onto the subject OB. The light source device 21 is, for example, a semiconductor laser emitting element. The light source device 21 emits pulsed laser light in accordance with control from a measurement controller 43.

The diffusion plate 22 is an optical component that diffuses the laser light in the near-infrared wavelength range emitted by the light source device 21 to the size of an area for irradiating the subject OB. The pulsed laser light diffused by the diffusion plate 22 is emitted as the light pulse PO and is irradiated onto the subject OB.

The light reception unit 3 receives the reflected light RL of the light pulse PO reflected by the subject OB, which is a target for distance measurement in the distance image capturing device 1, and outputs a pixel signal corresponding to the received reflected light RL. The light reception unit 3 includes a lens 31 and a distance image sensor 32.

The lens 31 is an optical lens that guides the incident reflected light RL to the distance image sensor 32. The lens 31 outputs the incident reflected light RL to the distance image sensor 32 side and causes the reflected light RL to be received by (to be incident on) the pixel circuit 321 provided in the light reception region of the distance image sensor 32.

The distance image sensor 32 is an imaging element used in the distance image capturing device 1. The distance image sensor 32 includes a plurality of pixel circuits 321 in a two-dimensional light reception region and a pixel drive circuit 322 that controls each of the pixel circuits 321.

The pixel circuit 321 is provided with one photoelectric conversion element (for example, a photoelectric conversion element PD described later), a plurality of charge accumulation units (for example, charge accumulation units CS (CS1 to CS4) described later) corresponding to the one photoelectric conversion element, and a component that distributes charges to each of the charge accumulation units.

The pixel drive circuit 322 causes each of transfer transistors G (described later) to conduct with each of the charge accumulation units CS (CS1 to CS4) at a predetermined accumulation timing synchronized with the irradiation of the light pulse PO, and distributes and accumulates the charges.

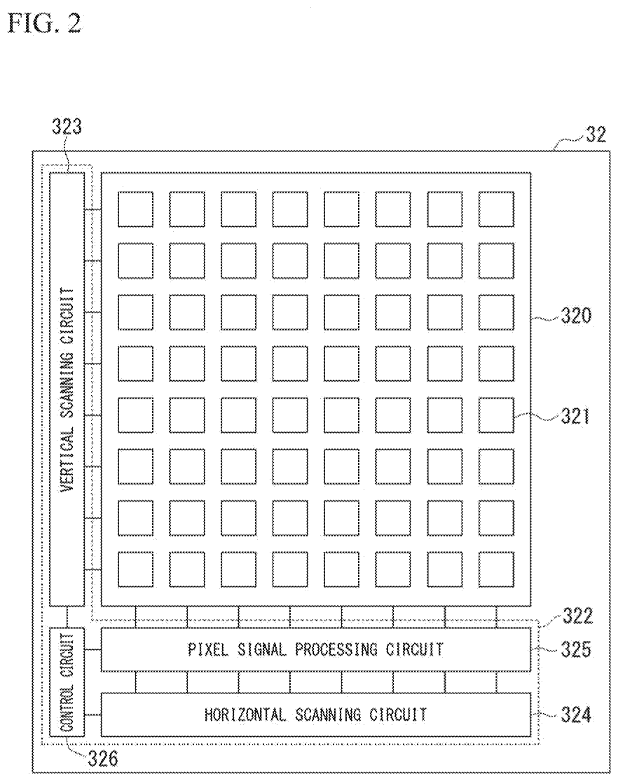

It is noted that the details of the distance image sensor 32 including the pixel circuit 321 and the pixel drive circuit 322 will be described later with reference to FIG. 2.

The distance image sensor 32 distributes the charges generated by the photoelectric conversion element to each of the charge accumulation units in accordance with the control from the measurement controller 43. In addition, the distance image sensor 32 outputs a pixel signal corresponding to the charge amount distributed to the charge accumulation unit. A plurality of pixel circuits are disposed in a two-dimensional matrix in the distance image sensor 32, and output pixel signals for one frame corresponding to each of the pixel circuits.

Here, a detailed configuration of the distance image sensor 32 will be described with reference to FIG. 2.

FIG. 2 is a block diagram showing an example of the distance image sensor 32 in the present embodiment.

As shown in FIG. 2, the distance image sensor 32 includes, for example, a light reception region 320 in which a plurality of pixel circuits 321 are disposed, and a pixel drive circuit 322. In addition, the pixel drive circuit 322 includes a vertical scanning circuit 323 having a distribution operation, a horizontal scanning circuit 324, a pixel signal processing circuit 325, and a control circuit 326.

The light reception region 320 is a region in which the plurality of pixel circuits 321 are disposed, and FIG. 2 shows an example in which the plurality of pixel circuits 321 are disposed in a two-dimensional matrix of 8 rows and 8 columns.

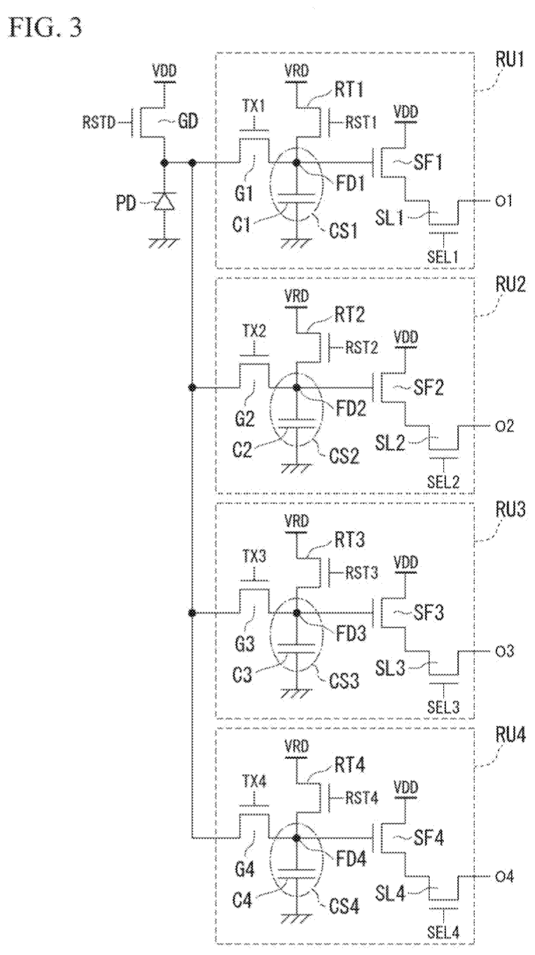

A plurality of pixel circuits 321 are disposed in a two-dimensional matrix, and accumulate charges corresponding to the amount of light received. It is noted that a detailed configuration of the pixel circuit 321 will be described later with reference to FIG. 3.

The control circuit 326 comprehensively controls the distance image sensor 32. The control circuit 326 controls the operation of the components of the distance image sensor 32 in response to, for example, an instruction from the measurement controller 43 of the distance image processing unit 4. It is noted that the components provided in the distance image sensor 32 may be controlled directly by the measurement controller 43, and in this case, the control circuit 326 can be omitted.

The vertical scanning circuit 323 is a circuit that controls the pixel circuits 321 disposed in the light reception region 320 for each row in accordance with control from the control circuit 326. The vertical scanning circuit 323 outputs a voltage signal corresponding to the charge amount accumulated in each of the charge accumulation units CS of the pixel circuits 321 to the pixel signal processing circuit 325. In this case, the vertical scanning circuit 323 distributes and accumulates the charges converted by the photoelectric conversion element in each of the charge accumulation units CS of the pixel circuits 321.

The pixel signal processing circuit 325 performs predetermined signal processing (for example, noise suppression processing or A/D conversion processing) on the voltage signal output from the pixel circuit 321 of each column in accordance with control from the control circuit 326.

The horizontal scanning circuit 324 is a circuit that sequentially outputs the signal output from the pixel signal processing circuit 325 in time series in accordance with control from the control circuit 326. As a result, the pixel signal corresponding to the charge amount accumulated for one frame is sequentially output to the distance image processing unit 4. In the following description, it is assumed that the pixel signal processing circuit 325 performs A/D conversion processing and the pixel signal is a digital signal.

Next, a configuration of the pixel circuit 321 disposed in the light reception region 320 provided in the distance image sensor 32 will be described with reference to FIG. 3.

FIG. 3 is a block diagram showing an example of the pixel circuit 321 in the present embodiment.

It is noted that the pixel circuit 321 shown in FIG. 3 is a configuration example including four pixel signal readout units RU (RU1 to RU4).

As shown in FIG. 3, the pixel circuit 321 includes one photoelectric conversion element PD, a charge discharge transistor GD, and four pixel signal readout units RU (RU1 to RU4) that output voltage signals from corresponding output terminals O (O1 to O4). Each of the pixel signal readout units RU includes a transfer transistor G, a floating diffusion FD, a charge accumulation capacitor C, a reset transistor RT, a source follower transistor SF, and a selection transistor SL. The floating diffusion FD and the charge accumulation capacitor C constitute a charge accumulation unit CS.

In the pixel circuit 321 shown in FIG. 3, the pixel signal readout unit RU1 that outputs a voltage signal from the output terminal O1 includes a transfer transistor G1, a floating diffusion FD1, a charge accumulation capacitor C1, a reset transistor RT1, a source follower transistor SF1, and a selection transistor SL1. In the pixel signal readout unit RU1, the floating diffusion FD1 and the charge accumulation capacitor C1 constitute a charge accumulation unit CS1. The pixel signal readout units RU2 to RU4 also have the same configuration.

The photoelectric conversion element PD is an embedded photodiode that photoelectrically converts incident light to generate a charge corresponding to the incident light and accumulates the generated charge. In the present embodiment, the incident light is incident from a space to be measured.

In the pixel circuit 321, the photoelectric conversion element PD distributes the charge generated by photoelectrically converting the incident light to each of the four charge accumulation units CS (CS1 to CS4), and outputs each voltage signal corresponding to the charge amount of the distributed charge to the pixel signal processing circuit 325.

In addition, the configuration of the pixel circuit 321 disposed in the distance image sensor 32 is not limited to the configuration including the four pixel signal readout units RU (RU1 to RU4) as shown in FIG. 3, and the pixel circuit 321 may have a configuration in which the pixel signal readout unit RU includes a plurality of pixel signal readout units RU of two or more. In addition, the pixel circuit 321 may have three or more pixel signal readout units RU.

In addition, in the driving of the pixel circuit 321, the light pulse PO is emitted at the irradiation time To, and the reflected light RL is received by the distance image sensor 32 with a delay time Td. The pixel drive circuit 322, in accordance with control by the measurement controller 43, supplies the accumulation drive signals TX1 to TX4 to the transfer transistors G (G1, G2, G3, and G4) at respective timing in synchronization with the irradiation of the light pulse PO on a frame-period basis, thereby distributing the charge generated in the photoelectric conversion element PD and causing the charge to be accumulated in the charge accumulation units CS1, CS2, CS3, and CS4 in this order.

In addition, the pixel drive circuit 322 controls each of the reset transistor RT and the selection transistor SL with the drive signals RST and SEL, converts the charge accumulated in the charge accumulation unit CS into an electric signal with the source follower transistor SF, and outputs the generated electric signal to the distance calculation unit 42 via the output terminal O.

The transfer transistor G is a transfer transistor corresponding to each of the plurality of charge accumulation units CS, and transfers the charge from the photoelectric conversion element PD to each charge accumulation unit CS.

In addition, the reset transistor RT discharges the charge accumulated in the charge accumulation unit CS (the floating diffusion FD and the charge accumulation capacitor C) and resets the charge accumulation unit.

In addition, the pixel drive circuit 322 sets the charge discharge transistor GD to an ON state with the drive signal RSTD in accordance with control of the measurement controller 43, and discharges the charge generated in the photoelectric conversion element PD by flowing the charge to the power supply VDD (erasing the charge).

Returning to the description of FIG. 1, the distance image processing unit 4 controls the distance image capturing device 1 and calculates the distance to the subject OB. The distance image processing unit 4 measures, based on a charge amount accumulated in each of the charge accumulation units CS, the distance to the subject OB present in the measurement space as a measurement distance. The distance image processing unit 4 measures, based on a charge amount accumulated in each of the charge accumulation units CS depending on a set number of times of distribution (number of times of integration) by repeatedly performing the distribution of the charge in one frame using the transfer transistor G, the distance to the subject OB present in the measurement space as a measurement distance.

In addition, the distance image processing unit 4 executes the control processing of HDR that realizes different numbers of times of distribution (number of times of integration) to the charge accumulation unit CS in one frame to cope with the imaging of the plurality of subjects OB having different reflectance or distances.

In the control processing of HDR, the distance image processing unit 4 controls the reset transistor RT such that, in each predetermined control unit of the pixel circuits 321 arranged in the two-dimensional matrix, the number of repetitions differs during a repetition period in which the charge is repeatedly distributed.

Here, the control unit is, for example, a row unit or a column unit in a two-dimensional matrix. In the control processing of HDR, the reset transistor RT is controlled such that the number of repetitions differs, for example, in a row unit (odd-numbered row and even-numbered row) or a column unit (odd-numbered column and even-numbered column).

Details of the processing of controlling the reset transistor RT, by the distance image processing unit 4, such that the number of repetitions differs will be described later.

The distance image processing unit 4 performs pre-measurement and main measurement in a case where the control processing of HDR is performed. The distance image processing unit 4 performs pre-measurement by a drive method capable of calculating the distance and the reflectance of the subject OB as the situation of the subject OB. Next, the distance image processing unit 4 performs the main measurement of controlling the reset transistor RT such that the number of repetitions differs in the control unit (for example, the odd-numbered row and the even-numbered row) of the pixel circuit 321 based on the situation of the subject OB present in the measurement space. Then, the distance image processing unit 4 calculates the measurement distance to the subject OB using HDR by the main measurement.

In addition, the distance image processing unit 4 includes a timing controller 41, a distance calculation unit 42, and the measurement controller 43.

The timing controller 41 controls a timing of outputting various control signals required for measurement in accordance with control of the measurement controller 43. The various control signals here are, for example, a signal for controlling the irradiation with the light pulse PO, a signal for distributing and accumulating the reflected light RL in the plurality of charge accumulation units CS, and a signal for controlling the number of times of accumulation per frame. The number of times of accumulation is the number of times of repeating the processing of distributing and accumulating the charge in the charge accumulation unit CS, and is the number of times of distribution set in advance in a frame cycle. The product of the number of times of accumulation and a time width (accumulation time width) for accumulating the charge in each charge accumulation unit CS per processing of distributing and accumulating the charge is an exposure time.

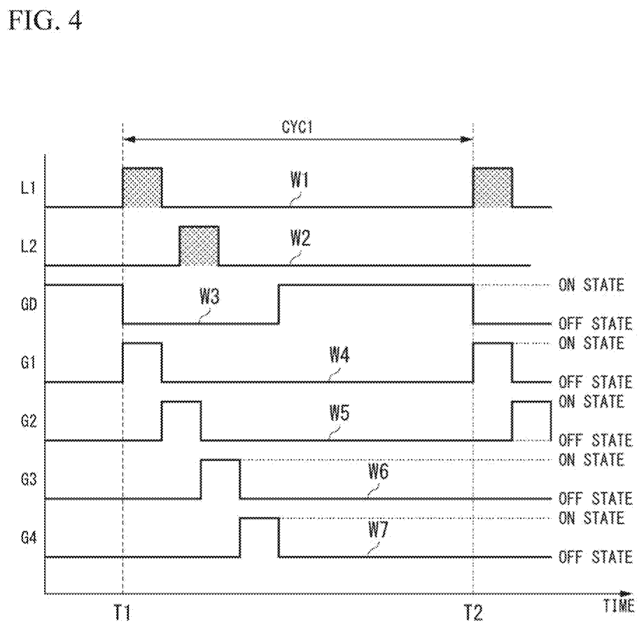

Here, the basic operation of the charge distribution processing of the distance image capturing device 1 will be described with reference to FIG. 4.

FIG. 4 is a diagram showing an example of the basic operation of the charge distribution processing of the distance image capturing device 1 according to the present embodiment. Here, the timing of the basic operation for one time of the number of times of accumulation is shown.

In FIG. 4, a waveform W1 indicates a state L1 of the irradiation of the light pulse PO, and a waveform W2 indicates a state L2 of the reception of the reflected light RL. In addition, waveforms W3 to W7 indicate the states of the charge discharge transistor GD and the transfer transistor G1 to the transfer transistor G4. In the waveforms W3 to W7, a High (H) state indicates an ON state (conductive state), and a Low (L) state indicates an OFF state (non-conductive state).

As shown in FIG. 4, in the basic operation for one time of the number of times of accumulation, first, at a time T1, the timing controller 41 causes the light source unit 2 to output the light pulse PO (see the waveform W1) and drives the pixel drive circuit 322 to set the charge discharge transistor GD to an OFF state (see the waveform W3).

Next, the timing controller 41 changes the transfer transistor G1 to the transfer transistor G4 to an ON state in order, and distributes and accumulates the charges generated by the photoelectric conversion element PD in the charge accumulation unit CS1 to the charge accumulation unit CS4 (see the waveforms W4 to W7). In addition, the timing controller 41 sets the transfer transistor G4 to an OFF state and then sets the charge discharge transistor GD to an ON state (see the waveform W3).

Next, at a time T2, the timing controller 41 causes the next light source unit 2 to output the light pulse PO (see the waveform W1) and drives the pixel drive circuit 322 to set the charge discharge transistor GD to an OFF state (see the waveform W3).

It is noted that in FIG. 4, a period CYC1 from the time T1 to the time T2 is a period of the basic operation for one time of the number of times of accumulation, and the charges are integrated in the charge accumulation unit CS1 to the charge accumulation unit CS4 by repeating the period CYC1.

In addition, the timing controller 41 executes, for example, control of the reset transistor RT for the above-described HDR.

The distance calculation unit 42 outputs distance information in which a distance to the subject OB is calculated based on the pixel signal output from the distance image sensor 32. The distance calculation unit 42 calculates a delay time from the irradiation with the light pulse PO to the reception of the reflected light RL based on the charge amounts accumulated in the plurality of charge accumulation units CS. The distance calculation unit 42 calculates the distance to the subject OB in accordance with the calculated delay time.

The distance calculation unit 42 calculates the delay time Td by Equation (1) by using the fact that the charge amounts corresponding to the reflected light RL components are distributed and accumulated in the two charge accumulation units CS at a ratio corresponding to the delay time Td until the reflected light RL is incident on the distance image capturing device 1. The distance calculation unit 42 calculates a round-trip distance to the subject OB by multiplying the delay time Td obtained by Equation (1) by the speed of light (velocity). The distance calculation unit 42 obtains the distance to the subject OB by setting the round-trip distance calculated above to ½. It is noted that in Equation (1), it is assumed that the charge amount corresponding to the external light component (disturbance light component) is accumulated in the charge accumulation unit CS1, and the charge amount corresponding to the reflected light RL component is distributed and accumulated in the charge accumulation units CS2 and CS3.

$$Td = To \times ( Q 3 - Q 1 ) / ( Q 2 + Q 3 - 2 \times Q 1 ) \qquad ( 1 )$$

Provided that To is a period during which the light pulse PO is irradiated.
Q1 is the charge amount accumulated in the charge accumulation unit CS1.
Q2 is the charge amount accumulated in the charge accumulation unit CS2.
Q3 is the charge amount accumulated in the charge accumulation unit CS3.

It is noted that the example shown in Equation (1) is an example in a case in which the charge amount of the reflected light RL, that is, the charge amount corresponding to the reflected light RL component is distributed and accumulated in the charge accumulation units CS2 and CS3. Therefore, for example, in a case where the charge is accumulated in the charge accumulation units CS1 and CS2 or the charge accumulation units CS3 and CS4, the basic method for calculating the delay time Td from the ratio of the charge amounts accumulated in the two charge accumulation units CS is the same, although the method is slightly different.

The measurement controller 43 controls the timing controller 41. For example, the measurement controller 43 sets the number of times of accumulation and the accumulation time width of one frame, and controls the timing controller 41 such that the imaging is performed with the set content.

The measurement controller 43 controls the timing controller 41 to execute the above-described pre-measurement, and causes the distance calculation unit 42 to calculate the distance to the subject OB and to calculate the reflectance of the subject OB. The measurement controller 43 determines, based on the situation of the subject OB, the distance to the subject OB and the reflectance as the situation of the subject OB, and the number of repetitions (number of times of accumulation) of the control unit (for example, the odd-numbered row unit and the even-numbered row unit) of the pixel circuit 321.

The measurement controller 43 controls the timing controller 41 such that the set number of repetitions differs, for example, in the odd-numbered row unit and the even-numbered row unit, and performs the main measurement.

In addition, the measurement controller 43 causes the distance calculation unit 42 to calculate the distance to the subject OB based on the main measurement. The measurement controller 43 executes the HDR processing by selecting, for example, any one of the distances by the pixel circuit 321 of the odd-numbered row and the distance by the pixel circuit 321 of the even-numbered row in accordance with the situation of the subject OB, and generates the distance image.

Next, an operation of the distance image capturing device 1 according to the present embodiment will be described with reference to the drawings.

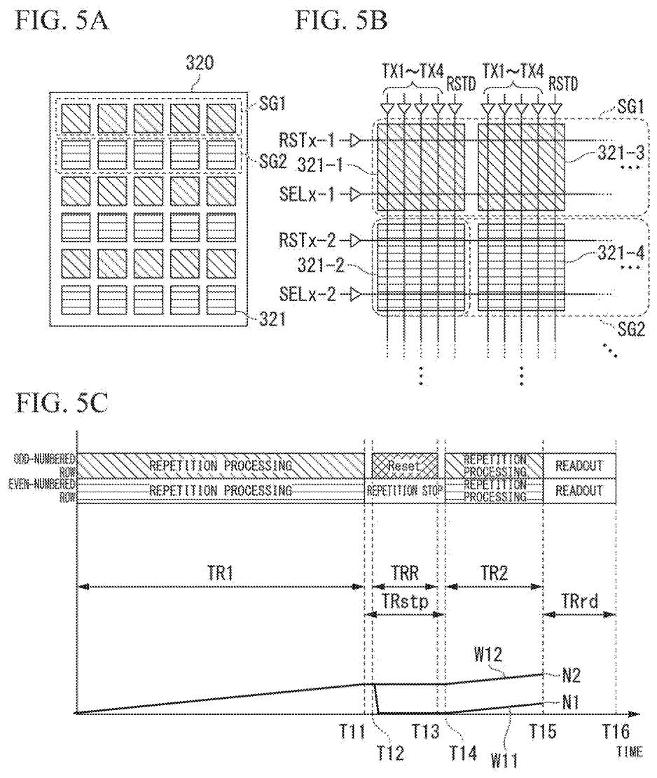

FIGS. 5A to 5C are diagrams illustrating an example of an operation of the HDR of the distance image capturing device 1 according to the present embodiment. Here, an example in which imaging is performed with different numbers of repetitions (number of times of accumulation) in the odd-numbered row and the even-numbered row of the pixel circuit 321 in one frame will be described.

FIG. 5A shows an example of the light reception region 320 of the distance image sensor 32.

In FIG. 5A, a group SG1 indicates a group (first pixel circuit group) of the pixel circuits 321 of the odd-numbered row, and a group SG2 indicates a group (second pixel circuit group) of the pixel circuits 321 of the even-numbered row.

In addition, FIG. 5B illustrates a drive signal in a case of performing the HDR of the distance image capturing device 1 according to the present embodiment.

In FIG. 5B, the pixel circuit 321-1 and the pixel circuit 321-3 are the group of the pixel circuits 321 of the odd-numbered row, and the pixel circuit 321-2 and the pixel circuit 321-4 are the group of the pixel circuits 321 of the even-numbered row.

As shown in FIG. 5B, a signal line (control line) of the drive signal RSTx-1 of the reset transistor RT and a signal line (control line) of the drive signal SELx-1 of the selection transistor SL are connected to the group SG1 of the pixel circuits 321 of the odd-numbered row. In addition, a signal line (control line) of the drive signal RSTx-2 of the reset transistor RT and a signal line (control line) of the drive signal SELx-2 of the selection transistor SL are connected to the group SG2 of the pixel circuits 321 of the even-numbered row.

It is noted that the drive signal RSTx indicates the drive signal RST1 to the drive signal RST4, and the drive signal SELx indicates the drive signal SEL1 to the drive signal SEL4.

In addition, the drive signal TX1 to the drive signal TX4 of the transfer transistor G1 to the transfer transistor G4 and the drive signal RSTD of the charge discharge transistor GD are common to the group SG1 and the group SG2.

In addition, FIG. 5C shows an example of the control processing of the HDR of the distance image capturing device according to the present embodiment using the distance image sensor 32 shown in FIGS. 5A and 5B.

In the “repetition processing” of FIG. 5C, the distance image processing unit 4 repeatedly executes the basic operation of the period CYC1 shown in FIG. 4 described above. In addition, in the “repetition stop”, the transfer transistor G1 to the transfer transistor G4 are set to OFF states by the drive signal TX1 to the drive signal TX4, and the charge discharge transistor GD is set to ON state by the drive signal RSTD.

In addition, in FIG. 5C, a waveform W1 indicates the number of repetitions of the group SG1 of the odd-numbered row, and a waveform W2 indicates the number of repetitions of the group SG2 of the even-numbered row.

As shown in FIG. 5C, the distance image processing unit 4 first executes the “repetition processing”, and temporarily sets the state to the “repetition stop” at time T11. That is, the distance image processing unit 4 sets the transfer transistor G1 to the transfer transistor G4 to an OFF state and sets the charge discharge transistor GD to an ON state.

The period TR1 from the start of the “repetition processing” to the time T11 corresponds to the first period.

Next, at time T12, the distance image processing unit 4 sets the reset transistor RT to an ON state for the group GR1 of the odd-numbered row to reset the charge accumulation unit CS of the odd-numbered tow. The distance image processing unit 4, for example, sets the drive signal RSTx-1 to the H state and sets the reset transistor RT of the odd-numbered line to an ON state. Here, the charge accumulation amount of the charge accumulation unit CS of the group SG1 of the odd-numbered row is reset, and the number of repetitions is also reset as shown in the waveform W1.

Next, at time T13, the distance image processing unit 4 sets the reset transistor RT to an OFF state for the group GR1 of the odd-numbered row, and at time T14, the distance image processing unit 4 restarts the “repetition processing” for the group GR1 of the odd-numbered row and for the group GR2 of the even-numbered row.

Here, the period TRR is the reset period of the group GR1 of the odd-numbered row, and the period TRstp is the period of the “repetition stop” of the group GP2 of the even-numbered row.

Next, at time T15, the distance image processing unit 4 ends the “repetition processing”. As a result, the number of repetitions of the group GR1 of the odd-numbered row is the number of times N1, the number of repetitions of the group GP2 of the even-numbered row is the number of times N2 (N2>N1), and different numbers of repetitions can be realized between the group GR1 of the odd-numbered row and the group GP2 of the even-numbered row.

It is noted that the period TR2 from time T14 to time T15 corresponds to the second period.

In addition, in the period TRrd from time T15 to time T16, the distance image processing unit 4 executes the charge reading processing of the charge accumulated in the charge accumulation unit CS of each pixel circuit 321. The period from the start of the first “repetition processing” to time T16 corresponds to the imaging period of one frame.

As shown in FIG. 5C, the distance image processing unit controls the reset transistor RT to perform reset of the charge for the group GR1 of the odd-numbered row (first pixel circuit group) and not to perform reset of the charge for the group GP2 of the even-numbered row (second pixel circuit group) after the charge is repeatedly distributed during a first period. The distance image processing unit 4 further performs control to repeatedly distribute the charge during the second period (period TR2) different from the first period (period TR1).

As a result, in one frame, the number of repetitions of the group GR1 of the odd-numbered row is the number of times N1, and the number of repetitions of the group GP2 of the even-numbered row is the number of times N2. The number of times N1 corresponds to the number of repetitions in the period TR2, and the number of times N2 corresponds to the number of repetitions in (the period TR1+the period TR2).

In addition, the distance image processing unit 4 generates the HDR distance image by using the pixel circuits 321 of the group GR1 of the odd-numbered row of the number of times N1 in a case where the reflectance of the subject OB is high (for example, 80% of reflectance or the like) and using the pixel circuits 321 of the group GR2 of the even-numbered row of the number of times N2 in a case where the reflectance of the subject OB is low (for example, 20% of reflectance or the like).

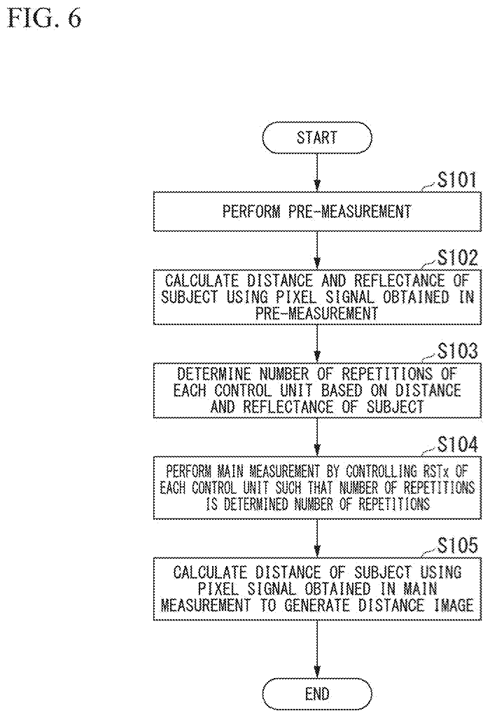

Next, control processing of the HDR of the distance image capturing device 1 according to the present embodiment will be described with reference to FIG. 6.

FIG. 6 is a flowchart illustrating an example of the control processing of the HDR of the distance image capturing device 1 according to the present embodiment.

As shown in FIG. 6, the distance image processing unit 4 of the distance image capturing device 1 first performs pre-measurement (Step S101). The distance image processing unit 4 executes the pre-measurement by using a drive method in which the distance and the relative reflectance of each of the plurality of subjects OB present in the measurement space are determined.

Next, the distance image processing unit 4 calculates the distance and the reflectance of the subject OB by using the pixel signal obtained in the pre-measurement (Step S102).

Next, the distance image processing unit 4 determines the number of repetitions of each control unit (for example, each of the odd-numbered row and the even-numbered row) based on the distance and the reflectance of the subject OB (Step S103). The distance image processing unit 4 sets the number of repetitions to be small in a case where the distance is short or the reflectance is high, and sets the number of repetitions to be large in a case where the distance is long or the reflectance is low.

Next, the distance image processing unit 4 performs the main measurement by controlling the drive signal RSTx of each control unit (for example, the odd-numbered row and the even-numbered row) such that the number of repetitions becomes the determined number of repetitions (Step S104). Specifically, the distance image processing unit 4 executes the main measurement by performing the control as shown in FIG. 5 described above.

Next, the distance image processing unit 4 calculates the distance of the subject OB by using the pixel signal obtained in the main measurement, and generates the distance image (Step S105). The distance image processing unit 4 generates the distance image by performing the HDR. The distance image capturing device 1 outputs the distance image generated by the distance image processing unit 4. After the processing of Step S105, the distance image processing unit 4 ends the processing.

As described above, the distance image capturing device 1 according to the present embodiment includes the light source unit 2, the light reception unit 3, and the distance image processing unit 4. The light source unit 2 irradiates the measurement space in which the subject OB exists with the light pulse PO. The light reception unit 3 includes a pixel circuit 321 and a pixel drive circuit 322. The pixel circuit 321 includes a photoelectric conversion element PD that generates a charge corresponding to incident light, and a plurality of charge accumulation units CS that accumulate the charge. The pixel drive circuit 322 distributes and accumulates the charge in each of the charge accumulation units CS in the pixel circuit 321 at a predetermined timing synchronized with the irradiation of the light pulse PO. The distance image processing unit 4 determines the measurement distance to the subject OB based on the charge amount accumulated in each of the charge accumulation units CS. A plurality of the pixel circuits 321 are disposed in a two-dimensional matrix. Each pixel circuit 321 includes a transfer transistor G that corresponds to each of the plurality of charge accumulation units CS and transfers the charge from the photoelectric conversion element PD to each charge accumulation unit CS, and a reset transistor RT that discharges the charge accumulated in the charge accumulation unit CS and resets the charge accumulation unit. The distance image processing unit 4 controls, in a case where the charge is repeatedly distributed using the transfer transistor G, the reset transistors RT such that, in each predetermined control unit of the pixel circuits 321 arranged in the two-dimensional matrix, the number of repetitions differs during a repetition period in which the charge is repeatedly distributed.

As a result, the distance image capturing device 1 according to the present embodiment can realize different numbers of repetitions in the control unit by controlling the reset transistor RT. Therefore, the distance image capturing device 1 according to the present embodiment can realize the HDR by simple control of controlling the reset transistor RT while suppressing an increase in the number of control lines (signal lines of the drive signals).

In addition, in the present embodiment, the pixel circuit 321 of the control unit includes a first pixel circuit group (group GR1 of the pixel circuits 321 in the odd-numbered rows) and a second pixel circuit group (group GR2 of the pixel circuits 321 in the even-numbered rows). The distance image processing unit 4 controls the reset transistor RT to perform reset of the charge for the first pixel circuit group and not to perform reset of the charge for the second pixel circuit group after the charge is repeatedly distributed during a first period (for example, a period TR1), and further performs control to repeatedly distribute the charge during a second period (for example, a period TR2) different from the first period.

As a result, the distance image capturing device 1 according to the present embodiment can realize, for example, two stages of the number of repetitions in the odd-numbered rows and the even-numbered rows in one frame by the control of whether or not to perform charge reset by the reset transistor RT.

In addition, in the present embodiment, the control unit is a row unit or a column unit in a two-dimensional matrix. As a result, the distance image capturing device 1 according to the present embodiment can realize different numbers of repetitions in the row unit or the column unit, and thus can realize the HDR in the row unit or the column unit.

In addition, in the present embodiment, the distance image processing unit 4 performs the pre-measurement by a drive method capable of calculating the distance and the reflectance of the subject OB as the situation of the subject OB. The distance image processing unit 4 performs the main measurement of controlling the reset transistor RT such that the number of repetitions differs in the control unit of the pixel circuit 321 based on the situation of the subject OB present in the measurement space. The distance image processing unit 4 calculates the measurement distance to the subject OB using the HDR by the main measurement.

As a result, the distance image capturing device 1 according to the present embodiment can more appropriately set the different numbers of repetitions by using the pre-measurement, and thus can realize the HDR with higher measurement accuracy.

In addition, the control method according to the present embodiment is the control method of the distance image capturing device 1 described above, and includes a control step. In the control step, the distance image processing unit 4 controls, in a case where the charge is repeatedly distributed using the transfer transistor G, the reset transistors RT such that, in each predetermined control unit of the pixel circuits 321 arranged in the two-dimensional matrix, the number of repetitions differs during a repetition period in which the charge is repeatedly distributed.

As a result, the control method according to the present embodiment has the same effect as the distance image capturing device 1 described above, and can realize the HDR by simple control of controlling the reset transistor RT while suppressing an increase in the number of control lines (signal lines of the drive signals).

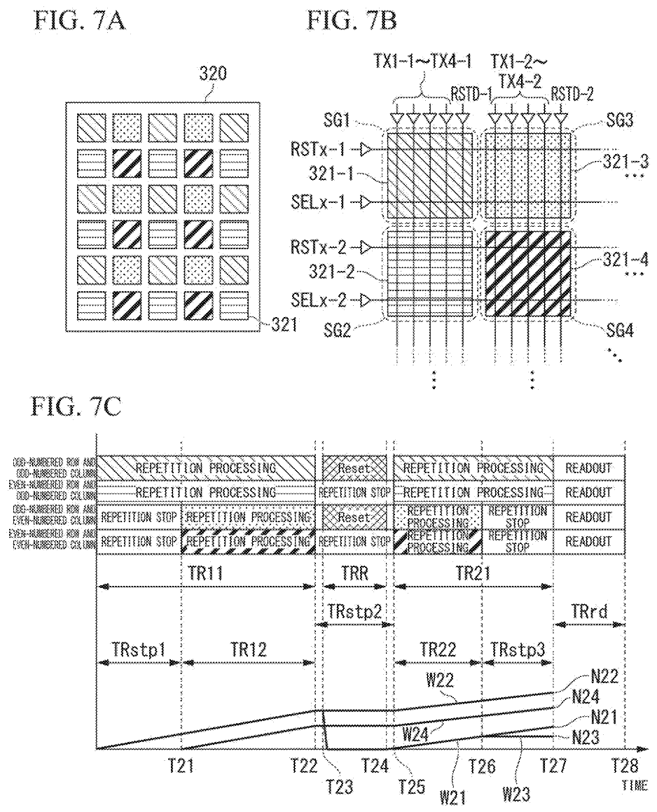

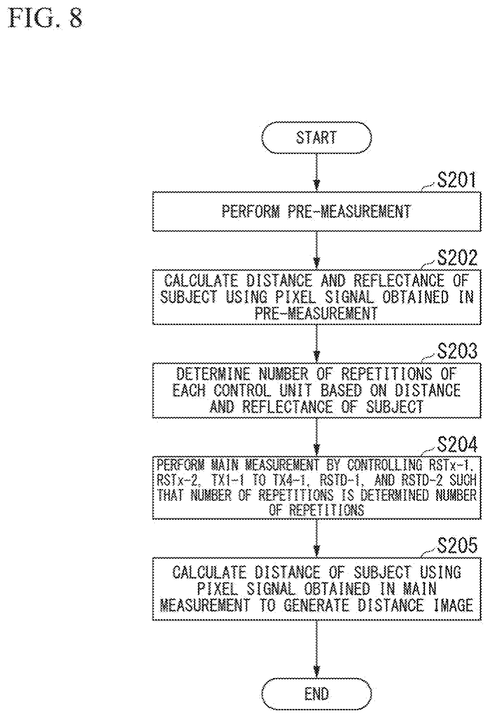

Next, a first modification example of the distance image capturing device 1 according to the present embodiment will be described with reference to FIGS. 7A to 7C and FIG. 8. In the first modification example, a modification example in which the control of the charge discharge transistor GD and the transfer transistor G is combined with the control of the reset transistor RT to realize, for example, four types of the number of repetitions of 2 rows×2 columns will be described.

FIGS. 7A to 7C are diagrams illustrating a first modification example of the operation of the HDR of the distance image capturing device 1 according to the present embodiment.

FIG. 7A shows an example of the light reception region 320 of the distance image sensor 32 of the first modification example in which the number of repetitions is controlled by 2 rows×2 columns.

FIG. 7A shows four types of groups (GR1, GR2, GR3, and GR4) of the pixel circuits 321 in an odd-numbered row and an odd-numbered column, an odd-numbered row and an even-numbered column, an even-numbered row and an odd-numbered column, and an even-numbered row and an even-numbered column.

In addition, FIG. 7B shows the drive signals when the distance image capturing device 1 is subjected to the HDR in the first modification example.

In FIG. 7B, the pixel circuit 321-1 shows a group SG1 in an odd-numbered row and an odd-numbered column, and the pixel circuit 321-2 shows a group SG2 in an even-numbered row and an odd-numbered column. In addition, the pixel circuit 321-3 shows a group SG3 in an odd-numbered row and an even-numbered column, and the pixel circuit 321-4 shows a group SG4 in an even-numbered row and an even-numbered column.

In addition, as shown in FIG. 7B, the drive signals TX1-1 to TX4-1 and the drive signal RSTD-1 are the drive signals for the odd-numbered column, and the drive signals TX1-2 to TX4-2 and the drive signal RSTD-2 are the drive signals for the even-numbered column.

In addition, FIG. 7C shows an example of the control processing of the HDR of the distance image capturing device according to the present embodiment using the distance image sensor 32 shown in FIGS. 7A and 7B.

In addition, in FIG. 7C, a waveform W21 indicates the number of repetitions of the group SG1 of the odd-numbered row and the odd-numbered column, and a waveform W22 indicates the number of repetitions of the group SG2 of the even-numbered row and the odd-numbered column. In addition, a waveform W23 indicates the number of repetitions of the group SG3 of the odd-numbered row and the even-numbered column, and a waveform W24 indicates the number of repetitions of the group SG4 of the even-numbered row and the even-numbered column.

As shown in FIG. 7C, the distance image processing unit 4 first executes the “repetition processing” on the odd-numbered column and sets the state to the “repetition stop” on the even-numbered column.

At time T21, the distance image processing unit 4 executes the “repetition processing” on the even-numbered column.

Next, at time T22, the distance image processing unit 4 temporarily sets the state to the “repetition stop”. That is, the distance image processing unit 4 sets the transfer transistor G1 to the transfer transistor G4 to an OFF state and sets the charge discharge transistor GD to an ON state.

It is noted that a period TRstp1 indicates a period of the “repetition stop” from the start of the processing to time T21. In addition, a period TR11 is a period of the “repetition processing” from the start of the processing to time T22, and a period TR12 is a period of the “repetition processing” from time T21 to time T22, and both correspond to the first period.

Next, at time T23, the distance image processing unit 4 sets the reset transistor RT to an ON state for the group (GR1 and GR3) of the odd-numbered row to reset the charge accumulation unit CS of the odd-numbered tow. The distance image processing unit 4, for example, sets the drive signal RSTx-1 to the H state and sets the reset transistor RT of the odd-numbered line to an ON state. Here, the charge accumulation amount of the charge accumulation unit CS of the group (GR1, GR3) of odd-numbered rows is reset, and the number of repetitions is also reset as shown in the waveform W21 and the waveform W23.

Next, at time T24, the distance image processing unit 4 sets the reset transistor RT to an OFF state for the group (GR1, GR3) of the odd-numbered row, and at time T25, the distance image processing unit 4 restarts the “repetition processing” for the group (GR1, GR3) of the odd-numbered row and for the group (GR2, GR4) of the even-numbered row.

Here, the period TRR is the reset period of the group (GR1, GR3) of the odd-numbered row, and the period TRstp2 is the period of the “repetition stop” of the group (GR2, GR4) of the even-numbered row.

Next, at time T26, the distance image processing unit 4 sets the state to the “repetition stop” again, for the group of even-numbered columns (GR3, GR4).

Next, at time T27, the distance image processing unit 4 ends the “repetition processing” for the group of even-numbered columns (GR1, GR2).

As a result of this control, the number of repetitions of the group GR1 of odd-numbered rows and odd-numbered columns is the number of times N21, and the number of repetitions of the group GR2 of even-numbered rows and odd-numbered columns is the number of times N22. In addition, the number of repetitions of the group GR3 of odd-numbered rows and even-numbered columns is the number of times N23, and the number of repetitions of the group GR4 of even-numbered rows and even-numbered columns is the number of times N24.

As described above, in the first modification example, four types of the number of repetitions can be realized.

It is noted that the period TR21 is a period from time T25 to time T27, and the period TR22 is a period from time T25 to time T26, and both correspond to the second period. In addition, the period TRstp3 indicates a period of the “repetition stop” from time T26 to time T27.

In addition, in the period TRrd from time T27 to time T28, the distance image processing unit 4 executes the charge reading processing of the charge accumulated in the charge accumulation unit CS of each pixel circuit 321. It is noted that a period from the start of the first “repetition processing” to time T28 corresponds to the imaging period of one frame.

As shown in FIG. 7C, the distance image processing unit 4 controls the charge discharge transistor GD and the reset transistor RT in combination such that the number of repetitions differs in accordance with the combination of the control of the charge discharge transistor GD and the control of the reset transistor RT during the repetition period. That is, the distance image processing unit 4 controls, in combination, control that sets the charge discharge transistor GD to a conductive state and the transfer transistor G to a non-conductive state, and control that sets the reset transistor RT to a conductive state, such that the number of repetitions differs.

As a result, in one frame, the group GR1 of the odd-numbered row and the odd-numbered column has the number of repetitions of the number N21, and the group GP2 of the even-numbered row and the odd-numbered column has the number of repetitions of the number N22. The number of times N21 corresponds to the number of repetitions in the period TR21, and the number of times N22 corresponds to the number of repetitions in (the period TR11+the period TR21).

In addition, in one frame, the group GR3 of the odd-numbered row and the even-numbered column has the number of repetitions of the number N23, and the group GP4 of the even-numbered row and the even-numbered column has the number of repetitions of the number N24. The number of times N23 corresponds to the number of repetitions in the period TR23, and the number of times N24 corresponds to the number of repetitions in (the period TR12+the period TR22).

Next, control processing of the HDR of the distance image capturing device 1 in the first modification example will be described with reference to FIG. 8.

FIG. 8 is a flowchart showing an example of the control processing of the HDR of the distance image capturing device 1 in the first modification example.

In FIG. 8, since the processing of Step S201 and Step S202 is the same as the processing of Step S101 and Step S102 shown in FIG. 6 described above, the description thereof will be omitted here.

In Step S203, the distance image processing unit 4 determines the number of repetitions of each control unit (for example, each of the odd-numbered row and the even-numbered row) based on the distance and the reflectance of the subject OB. As shown in FIG. 7 described above, the distance image processing unit 4 determines four types of the number of repetitions.

Next, the distance image processing unit 4 performs the main measurement by controlling the drive signal RSTx-1, the drive signal RSTx-2, the drive signal TX1-1 to the drive signal TX4-1, the drive signal TX1-2 to the drive signal TX4-2, the drive signal RSTD-1, and the drive signal RSTD-2 such that the number of repetitions is the determined number of repetitions. Specifically, the distance image processing unit 4 executes the main measurement by performing the control as shown in FIG. 7 described above.

Next, the distance image processing unit 4 calculates the distance of the subject OB by using the pixel signal obtained in the main measurement, and generates the distance image (Step S205). The distance image processing unit 4 generates the distance image by performing the HDR. The distance image capturing device 1 outputs the distance image generated by the distance image processing unit 4. After the processing of Step S205, the distance image processing unit 4 ends the processing.

As described above, in the first modification example, each pixel circuit 321 further includes the charge discharge transistor GD that discharges the charge from the photoelectric conversion element PD. The distance image processing unit 4 controls the charge discharge transistor GD and the reset transistor RT in combination such that the number of repetitions differs in accordance with the combination of the control of the charge discharge transistor GD and the control of the reset transistor RT during the repetition period. That is, the distance image processing unit 4 controls, in combination, control that sets the charge discharge transistor GD to a conductive state and the transfer transistor G to a non-conductive state, and control that sets the reset transistor RT to a conductive state, such that the number of repetitions differs.

As a result, the distance image capturing device 1 according to the present embodiment can realize, in one frame, for example, four types of the number of repetitions of 2 rows×2 columns by combining control that sets the charge discharge transistor GD to a conductive state and the transfer transistor G to a non-conductive state, and control that sets the reset transistor RT to a conductive state.

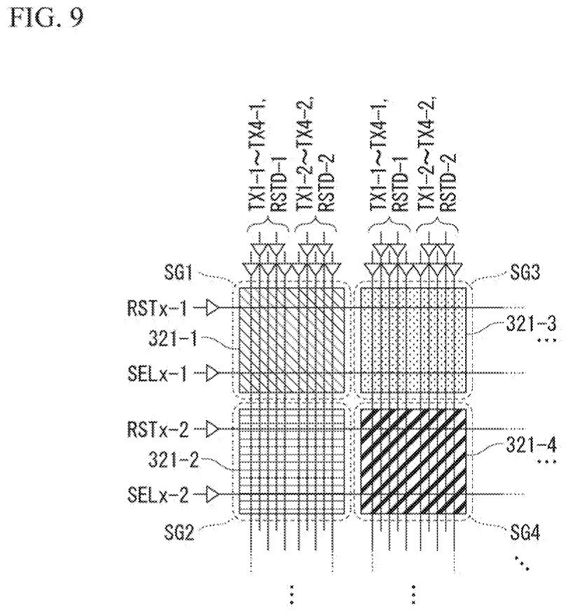

It is noted that FIG. 9 is a diagram showing an example of a distance image sensor in a case where the HDR is performed in the distance image capturing device of the related art, for comparison.

As shown in FIG. 9, in the distance image capturing device of the related art, in a case where the four different numbers of repetitions of 2 rows×2 columns are to be realized, it is necessary to pass two systems of signal lines of the drive signal TX1-1 to the drive signal TX4-1 and the drive signal RSTD-1 and the drive signal TX1-2 to the drive signal TX4-2 and the drive signal RSTD-2 through the pixel circuit 321 of one column. Therefore, in the distance image capturing device of the related art, the size of the distance image sensor is increased, and the control is also complicated.

On the other hand, in the distance image capturing device 1 of the first modification example of the present embodiment, as shown in FIG. 7, the pixel circuit 321 of one column can be controlled by one system of signal lines, and the HDR can be realized by simple control while suppressing an increase in the number of control lines and an increase in the size of the distance image sensor 32.

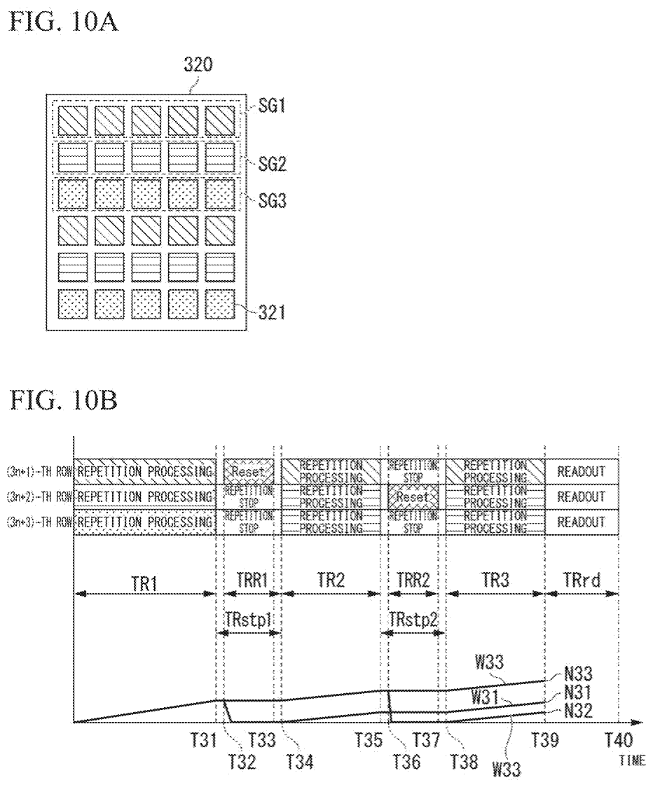

Next, a second modification example of the distance image capturing device 1 according to the present embodiment will be described with reference to FIG. 10. In the second modification example, a modification example in which a plurality of timings of the control of the reset transistor RT are provided and three or more different numbers of repetitions are realized, such as three different numbers of repetitions in three rows, will be described.

FIGS. 10A and 10B are diagrams showing a second modification example of the operation of the HDR of the distance image capturing device 1 according to the present embodiment.

FIG. 10A shows an example of the light reception region 320 of the distance image sensor 32 of the second modification example in which the three different numbers of repetitions are controlled in units of rows.

In FIG. 10A, a group SG1 indicates a group of a (3n+1)-th row, a group SG2 indicates a group of a (3n+2)-th row, and a group SG3 indicates a group of a (3n+3)-th row. Here, n is 0 and a positive integer.

In addition, FIG. 10B shows an example of the control processing of the HDR of the distance image capturing device according to the present embodiment using the distance image sensor 32 shown in FIG. 10A.

In addition, in FIG. 10B, a waveform W31 indicates the number of repetitions of the group SG1 of the (3n+1)-th row, a waveform W32 indicates the number of repetitions of the group SG2 of the (3n+2)-th row, and a waveform W33 indicates the number of repetitions of the group SG3 of the (3n+3)-th row.

As shown in FIG. 10B, the distance image processing unit 4 first executes the “repetition processing”, and at time T31, the distance image processing unit 4 temporarily sets the state to the “repetition stop”. That is, the distance image processing unit 4 sets the transfer transistor G1 to the transfer transistor G4 to an OFF state and sets the charge discharge transistor GD to an ON state.

Next, at time T32, the distance image processing unit 4 sets the reset transistor RT to an ON state for the group GR1 of the (3n+1)-th row, and resets the charge accumulation unit CS of the (3n+1)-th row.

Next, at time T33, the distance image processing unit 4 sets the reset transistor RT to an OFF state for the group GR1 of the (3n+1)-th row, and at time T34, the distance image processing unit 4 restarts the “repetition processing” for the group GR1 of the (3n+1)-th row, the group GR2 of the (3n+2)-th row, and the group GR3 of the (3n+3)-th row.

Here, the period TRR1 is the reset period of the group GR1 of the (3n+1)-th row, and the period TRstp1 is the period of the “repetition stop” of the group GR2 of the (3n+2)-th row and the group GR3 of the (3n+3)-th row.

Next, at time T35, the distance image processing unit 4 temporarily sets the state to the “repetition stop”. That is, the distance image processing unit 4 sets the transfer transistor G1 to the transfer transistor G4 to an OFF state and sets the charge discharge transistor GD to an ON state.

Next, at time T36, the distance image processing unit 4 sets the reset transistor RT to an ON state for the group GR2 of the (3n+2)-th row, and initializes the charge accumulation unit CS of the (3n+2)-th row.

Next, at time T37, the distance image processing unit 4 sets the reset transistor RT to an OFF state for the group GR2 of the (3n+2)-th row, and at time T38, the distance image processing unit 4 restarts the “repetition processing” for the group GR1 of the (3n+1)-th row, the group GR2 of the (3n+2)-th row, and the group GR3 of the (3n+3)-th row.

Here, the period TRR2 is the reset period of the group GR2 of the (3n+2)-th row, and the period TRstp2 is the period of the “repetition stop” of the group GR1 of the (3n+1)-th row and the group GR3 of the (3n+3)-th row.

Next, at time T39, the distance image processing unit 4 ends the “repetition processing”. As a result, the number of repetitions of the group GR1 of the (3n+1)-th row is the number of times N31, the number of repetitions of the group GR2 of the (3n+2)-th row is the number of times N32, and the number of repetitions of the group GR3 of the (3n+3)-th row is the number of times N33. Therefore, three different numbers of times of repetition can be realized.

In addition, in the period TRrd from time T39 to time T40, the distance image processing unit 4 executes the charge reading processing of the charge accumulated in the charge accumulation unit CS of each pixel circuit 321. The period from the start of the first “repetition processing” to time T40 corresponds to the imaging period of one frame.

As described above, in the second modification example of the present embodiment, the distance image processing unit 4 controls by changing the timing at which the reset transistor RT is set to an ON state (conductive state) during the repetition period such that the number of repetitions takes a plurality of different values in the control unit.

As a result, the distance image capturing device 1 in the second modification example of the present embodiment can realize, for example, three or more different numbers of repetitions in one frame by changing the timing at which the reset transistor RT is set to an ON state (conductive state), as shown in FIG. 10.

It is noted that the present invention is not limited to the above-described embodiments, and can be changed without departing from the gist of the present invention.

For example, in the above-described embodiment, an example in which the pixel circuit 321 includes four charge accumulation units CS (CS1, CS2, CS3, and CS4) has been described, but the present invention is not limited thereto, and the pixel circuit 321 may include N charge accumulation units CS, where N is 3 or more.

In addition, in the above-described embodiment, an example in which the control of the reset transistor RT and the control of the charge discharge transistor GD and the transfer transistor G are combined to realize four different numbers of repetitions of 2 rows×2 columns in one frame has been described, but the present invention is not limited thereto. The distance image processing unit 4 may control the number of repetitions to be (N×M) different numbers of repetitions of N rows×M columns, for example, by combining the control of the reset transistor RT and the control of the charge discharge transistor GD and the transfer transistor G.

It is noted that each configuration included in the distance image capturing device 1 described above includes a computer system therein. A program for realizing the function of each configuration included in the distance image capturing device 1 described above may be recorded on a computer-readable recording medium, and the program recorded on the recording medium may be read into the computer system and executed to perform processing in each configuration included in the distance image capturing device 1 described above. Here, the expression “the program recorded on the recording medium is read into the computer system and executed” includes installing the program in the computer system. The term “computer system” as used herein includes an OS or hardware such as a peripheral device.

In addition, the “computer system” may include a plurality of computer devices connected via a network including a communication line such as the Internet, a WAN, a LAN, or a dedicated line. Furthermore, the term “computer-readable recording medium” refers to a portable medium such as a flexible disk, a magneto-optical disk, a ROM, or a CD-ROM, or a storage device such as a hard disk built in the computer system. As described above, the recording medium in which the program is stored may be a non-transitory recording medium such as a CD-ROM.

In addition, the recording medium also includes a recording medium provided inside or outside the computer system that is accessible from a distribution server for distributing the program. It is noted that a configuration in which the program is divided into a plurality of parts, downloaded at different timings, and then combined in each configuration included in the distance image capturing device 1, or a configuration in which the distribution servers that distribute the divided programs are different may be adopted. Furthermore, the term “computer-readable recording medium” also includes a medium that holds the program for a certain period of time, such as a volatile memory (RAM) inside a computer system that is a server or a client when the program is transmitted via a network. In addition, the above program may be a program for implementing a part of the above-described functions. Furthermore, the program may be a so-called difference file (difference program) that can implement the above-described functions in combination with a program already recorded in the computer system.

In addition, a part or all of the above-described functions may be realized as an integrated circuit such as a large-scale integration (LSI). Each of the above-described functions may be individually processed by a processor, or a part or all of the functions may be integrated and processed by a processor. In addition, the method of integrating the circuit is not limited to the LSI, and may be realized by a dedicated circuit or a general-purpose processor. In addition, when a technology for implementing an integrated circuit that replaces the LSI appears due to the advancement of semiconductor technology, an integrated circuit using the technology may be used.

While preferred embodiments of the invention have been described and illustrated above, it should be understood that these are exemplary examples of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

What is claimed is:

1. A distance image capturing device comprising:
a light source unit configured to irradiate a measurement space in which a subject exists with a light pulse;
a light reception unit including a pixel circuit and a pixel drive circuit, the pixel circuit including a photoelectric conversion element configured to generate charge corresponding to incident light and a plurality of charge accumulation units configured to accumulate the charge, the pixel drive circuit being configured to, at a predetermined timing synchronized with irradiation of the light pulse, distribute the charge to each of the charge accumulation units in the pixel circuit and accumulate the charge in each of the charge accumulation units; and
a distance image processing unit configured to determine a measurement distance to the subject based on a charge amount accumulated in each of the charge accumulation units,
wherein a plurality of the pixel circuits are disposed in a two-dimensional matrix,
each of the pixel circuits includes
a transfer transistor corresponding to each of the plurality of charge accumulation units, the transfer transistor being configured to transfer the charge from the photoelectric conversion element to each of the charge accumulation units, and
a reset transistor configured to discharge the charge accumulated in the charge accumulation units and reset the charge accumulation units, and
the distance image processing unit causes the transfer transistor to repeatedly distribute the charge, and controls the reset transistors such that, in each predetermined control unit of the pixel circuits arranged in the two-dimensional matrix, the number of repetitions differs during a repetition period in which the charge is repeatedly distributed.

2. The distance image capturing device according to claim 1,
wherein the pixel circuits of the control unit include a first pixel circuit group and a second pixel circuit group, and
the distance image processing unit controls the reset transistor to perform reset of the charge for the first pixel circuit group and not to perform reset of the charge for the second pixel circuit group after the charge is repeatedly distributed during a first period, and further performs control to repeatedly distribute the charge during a second period different from the first period.

3. The distance image capturing device according to claim 2,
wherein the control unit is a row unit or a column unit in the two-dimensional matrix.

4. The distance image capturing device according to claim 1,
wherein each of the pixel circuits further includes a charge discharge transistor configured to discharge the charge from the photoelectric conversion element, and
the distance image processing unit, during the repetition period, controls the charge discharge transistor and the reset transistor in combination such that the number of repetitions differs in accordance with a combination of control of the charge discharge transistor and control of the reset transistor.

5. The distance image capturing device according to claim 4,
wherein the distance image processing unit controls, in combination, control that sets the charge discharge transistor to a conductive state and the transfer transistor to a non-conductive state, and control that sets the reset transistor to a conductive state, such that the number of repetitions differs.

6. The distance image capturing device according to claim 1,
wherein the distance image processing unit, during the repetition period, controls timing at which the reset transistor is set to a conductive state by changing the timing for each control unit, such that the number of repetitions takes a plurality of different values in the control unit.

7. The distance image capturing device according to claim 1,
wherein the distance image processing unit performs pre-measurement by a drive method enabling calculation of a distance and a reflectance of the subject as a situation of the subject,
performs main measurement in which, based on the situation of the subject existing in the measurement space, the reset transistor is controlled such that the number of repetitions differs in the control unit of the pixel circuits, and
calculates a measurement distance to the subject using a high dynamic range (HDR) by the main measurement.

8. The distance image capturing device according to claim 7,
wherein the plurality of charge accumulation units are three or more charge accumulation units.

9. A control method of a distance image capturing device, the distance image capturing device including
a light source unit configured to irradiate a measurement space in which a subject exists with a light pulse,
a light reception unit including a pixel circuit and a pixel drive circuit, the pixel circuit including a photoelectric conversion element configured to generate charge corresponding to incident light and a plurality of charge accumulation units configured to accumulate the charge, the pixel drive circuit being configured to, at a predetermined timing synchronized with irradiation of the light pulse, distribute the charge to each of the charge accumulation units in the pixel circuit and accumulate the charge in each of the charge accumulation units, and
a distance image processing unit configured to determine a measurement distance to the subject based on a charge amount accumulated in each of the charge accumulation units,
in which a plurality of the pixel circuits are disposed in a two-dimensional matrix,
each of the pixel circuits includes
a transfer transistor corresponding to each of the plurality of charge accumulation units, the transfer transistor being configured to transfer the charge from the photoelectric conversion element to each of the charge accumulation units, and
a reset transistor configured to discharge the charge accumulated in the charge accumulation units and reset the charge accumulation units, the control method comprising:
a control step of causing, by the distance image processing unit, the transfer transistor to repeatedly distribute the charge, and controlling the reset transistors such that, in each predetermined control unit of the pixel circuits arranged in the two-dimensional matrix, the number of repetitions differs during a repetition period in which the charge is repeatedly distributed.
